(19) United States
(12) Patent Application Publication
(10) Pub. No.: US 2007/0049223 A1
(43) Pub. Date: Mar. 1, 2007

(54) Radio Receiver and Radio Receiving Method

(75) Inventors: Hideshi Nishizawa, Kobe-shi, Hyogo (JP); Osamu Mino, Kobe-shi (JP)

Correspondence Address: FOGG AND ASSOCIATES, LLC, P.O. BOX 581339, MINNEAPOLIS, MN, 55458-1339, US

(73) Assignee: FUJITSU-TEN LIMITED, Kobe-shi (JP)

(21) Appl. No.: 11/466,659

(22) Filed: Aug. 23, 2006

(30) Foreign Application Priority Data
Aug. 24, 2005 (JP) 2005-242601

(51) Int. Cl. H04B 1/18

(52) U.S. Cl. 455/182.3

(57) ABSTRACT

The present invention is directed to the provision of a radio receiver and of a radio receiving method that can reliably detect IBOC hybrid broadcast carrier waves. The radio receiver includes a tuning section for tuning to the frequency of a broadcast carrier wave, a detection section for detecting the signal level of the broadcast carrier wave at the frequency to which the tuning section has tuned, and a control section for detecting an IBOC hybrid broadcast carrier wave, based on a first signal level detected by the detection section by causing the tuning section to tune to a first frequency, a second signal level detected by the detection section by causing the tuning section to tune to a second frequency, and a third signal level detected by the detection section by causing the tuning section to tune to a third frequency. The radio receiving method is implemented in such a radio receiver.

This application is a new U.S. patent application that claims benefit from JP 2005-242601, filed on Aug. 24, 2005. The entire content of JP 2005-242601 is hereby incorporated by reference.

### FIELD OF THE INVENTION

The present invention relates to a radio receiver and a radio receiving method and, more particularly, to an HD (High Definition) radio receiver capable of receiving IBOC (In-Band On-Channel) hybrid broadcast carrier waves and a radio receiving method for the same.

### BACKGROUND OF THE INVENTION

When an IBOC hybrid broadcast carrier wave is employed that enables digital broadcast carrier waves to be transmitted together with an analog broadcast carrier wave, an HD radio receiver capable of receiving such digital broadcast carrier waves can reproduce sound with an improved quality by using the digital broadcast carrier waves. The digital broadcast carrier waves contained in such an IBOC hybrid broadcast carrier wave are placed in sidebands on both sides of the analog broadcast carrier wave but within the frequency band thereof (refer, for example, to patent document 1).

However, as not all broadcast stations are expected to transmit IBOC hybrid broadcast carrier waves simultaneously, there can occur a situation where some broadcast stations are broadcasting by carrying digital broadcast carrier waves on both sides of a particular analog broadcast carrier wave, while other stations are broadcasting by using only analog broadcast carrier waves. When an HD radio receiver performs a seek operation in such a situation, a first analog broadcast carrier wave may interfere with one of the digital broadcast carrier waves carried on both sides of a second analog broadcast carrier wave, resulting in an erroneous detection.

Patent Document 1: JP-A-2000-4174 (FIG. 3, page 3)

### SUMMARY OF THE INVENTION

It is an object of the present invention to provide a radio receiver and a radio receiving method that can reliably detect IBOC hybrid broadcast carrier waves.

A radio receiver according to the present invention includes a tuning section for tuning to the frequency of a broadcast carrier wave, a detection section for detecting the signal level of the broadcast carrier wave at the frequency to which the tuning section has tuned, and a control section for detecting an IBOC hybrid broadcast carrier wave, based on a first signal level detected by the detection section by causing the tuning section to tune to a first frequency, a second signal level detected by the detection section by causing the tuning section to tune to a second frequency, and a third signal level detected by the detection section by causing the tuning section to tune to a third frequency.

Preferably, in the radio receiver according to the present invention, the control section determines that an IBOC hybrid broadcast carrier wave has been detected, when the first signal level, the second signal level and the third signal level are each larger than a predetermined level. This is to enhance the detection accuracy of the hybrid broadcast carrier wave.

Further preferably, in the radio receiver according to the present invention, the control section determines that an IBOC hybrid broadcast carrier wave has been detected, when the first signal level and the third signal level are substantially equal to each other. This is to further enhance the detection accuracy of the hybrid broadcast carrier wave.

Further preferably, in the radio receiver according to the present invention, the control section determines that an IBOC hybrid broadcast carrier wave has been detected when the difference between the first signal level and the second signal level is substantially equal to a predetermined level difference. This is to further enhance the detection accuracy of the hybrid broadcast carrier wave.

Further preferably, in the radio receiver according to the present invention, the control section determines that an IBOC hybrid broadcast carrier wave has been detected when the first signal level and the third signal level are substantially equal to each other, and when the difference between the first signal level and the second signal level is substantially equal to a predetermined level difference. This is to further enhance the detection accuracy of the hybrid broadcast carrier wave.

Preferably, in the radio receiver according to the present invention, the first frequency, the second frequency, and the third frequency are separated from one another by a prescribed frequency interval.

Preferably, the radio receiver according to the present invention includes a plurality of tuning sections paired with a plurality of detection sections, and tuning to different frequencies and detection of signal levels at the different frequencies are performed by the plurality of tuning sections and detection sections. When performing a seek operation, speedup of the seek operation can be achieved by performing the tuning operation and the signal level detection concurrently on adjacent channels.

A radio receiver according to the present invention includes a tuning section for tuning to the frequency of a broadcast carrier wave, a detection section for detecting signal level of the broadcast carrier wave at the frequency to which the tuning section has tuned; a generating section for generating SIS data from a digital broadcast carrier wave contained in the broadcast carrier wave, and a control section for determining that an IBOC hybrid broadcast carrier wave has been detected when the signal level detected by the detection section is larger than a predetermined signal level and when SIS data is generated by the generating section. That is, when SIS data is generated, it is determined that the radio receiver has tuned to a digital broadcast carrier wave.

A radio receiver according to the present invention includes a tuning section for tuning to the frequency of a broadcast carrier wave, a detection section for detecting the signal level of the broadcast carrier wave at the frequency to which the tuning section has tuned; a generating section for generating audio data corresponding to a digital broadcast from a digital broadcast carrier wave contained in the broadcast carrier wave, and a control section for determining that an IBOC hybrid broadcast carrier wave has been detected, when the signal level detected by the detection section is larger than a predetermined signal level and when audio data is generated by the generating section. That is, when audio data corresponding to a digital broadcast is generated, it is determined that the radio receiver is tuned to a digital broadcast carrier wave.

A radio receiver according to the present invention includes a tuning section for tuning to the frequency of a broadcast carrier wave, a detection section for detecting the signal level of said broadcast carrier wave at the frequency to which said tuning section has tuned, and a control section for detecting an IBOC hybrid broadcast carrier wave based on a level difference between a first signal level, detected by said detection section by causing said tuning section to tune to a first frequency, and a second signal level, detected by said detection section by causing said tuning section to tune to a second frequency which is separated from said first frequency by a prescribed frequency step.

A radio receiving method according to the present invention includes the steps of detecting the signal level of a first broadcast carrier wave by tuning to a first frequency, detecting the signal level of a second broadcast carrier wave by tuning to a second frequency, detecting the signal level of a third broadcast carrier wave by tuning to a third frequency, and detecting an IBOC hybrid broadcast carrier wave, based on the signal level of the first broadcast carrier wave, the signal level of the second broadcast carrier wave, and the signal level of the third broadcast carrier wave. In this method, when broadcast carrier waves exist, for example, on three adjacent channels, it is determined that a hybrid broadcast carrier wave has been detected.

A radio receiving method according to the present invention includes the steps of detecting the signal level of a broadcast carrier wave by tuning to the frequency of the broadcast carrier wave and determining that an IBOC hybrid broadcast carrier wave has been detected, when the signal level is larger than a predetermined signal level and when SIS data is generated from a digital broadcast carrier wave contained in the broadcast carrier wave.

A radio receiving method according to the present invention includes the steps of detecting the signal level of a broadcast carrier wave by tuning to the frequency of the broadcast carrier wave, and determining that an IBOC hybrid broadcast carrier wave has been detected, when the signal level is larger than a predetermined signal level and when audio data corresponding to a digital broadcast is generated from a digital broadcast carrier wave contained in the broadcast carrier wave.

A radio receiving method according to the present invention includes the steps of detecting the signal level of a first broadcast carrier wave by tuning to a first frequency, detecting signal level of a second broadcast carrier wave by tuning to a second frequency, and detecting an IBOC hybrid broadcast carrier wave, based on the level difference between the signal level of the first broadcast carrier and the signal level of the second broadcast carrier.

According to the radio receiver and radio receiving method of the present invention, as the presence of an IBOC hybrid broadcast carrier wave is detected by identifying its characteristic structure, the IBOC hybrid broadcast carrier wave can be detected reliably and accurately.

Furthermore, according to the radio receiver and radio receiving method comprising a plurality of tuning sections and signal generating sections, the time required for the seek operation can be shortened.

### BRIEF DESCRIPTION OF THE DRAWINGS

FIG. 1 is a block diagram showing the basic configuration of a radio receiver according to the present invention.

FIG. 2(a) is a diagram showing an IBOC FM hybrid broadcast carrier wave, and FIG. 2(b) is a diagram showing an IBOC AM hybrid broadcast carrier wave.

FIG. 3 is a flow diagram showing a radio receiving method according to the present invention.

FIG. 4 is a diagram for explaining a seek operation.

### DETAILED DESCRIPTION OF THE PREFERRED EMBODIMENTS

A radio receiver and a radio receiving method according to the present invention will be described below with reference to the drawings. It is to be understood, however, that the invention is not limited to the drawings or the specific embodiment described herein.

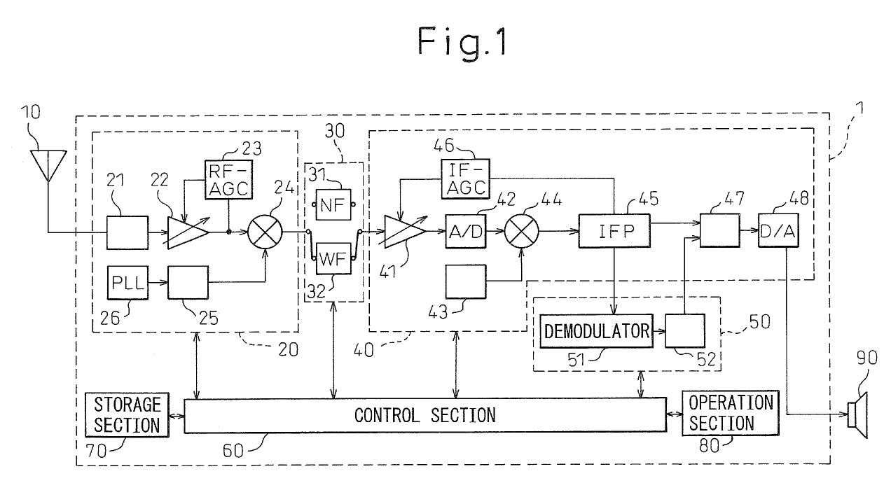

FIG. 1 is a diagram showing the basic configuration of the radio receiver according to the present invention.

The radio receiver 1 comprises a preprocessing section 20, an IF (Intermediate Frequency) filter circuit 30, a digital signal processing section 40, an IBOC processing section 50, a control section 60 containing a CPU, etc., a storage section 70 containing a RAM, a ROM, and/or other various kinds of memories, and an operation section 80, and is connected to an antenna 10 and a sound output section 90 such as a speaker.

The preprocessing section 20, which is controlled by the control section 60, comprises a tuning circuit 21 of an electronic tuning type which receives a signal from the antenna 10, an RF (Radio Frequency) amplifier circuit 22, an RF-AGC (Auto Gain Control) circuit 23, a first mixer circuit 24, a first local oscillator circuit 25, and a PLL tuning circuit 26. The RF amplifier circuit 22 is constructed so that its gain is adjusted by the RF-AGC circuit 23, and an S level signal (a signal indicating the electric field condition) supplied from the RF-AGC circuit 23 is used when detecting an IBOC digital broadcast carrier wave, as will be described later. The first local oscillator circuit 25, which is implemented with a PLL synthesizer, generates a first local oscillator signal, in prescribed frequency steps, in accordance with a PLL control signal supplied from the PLL tuning circuit 26 based on a control signal from the control section 60. The received radio-frequency signal amplified by the RF amplifier circuit 22 is mixed in the first mixer circuit 24 with the first local oscillator signal for conversion into an intermediate frequency signal which is input to the IF filter circuit 30.

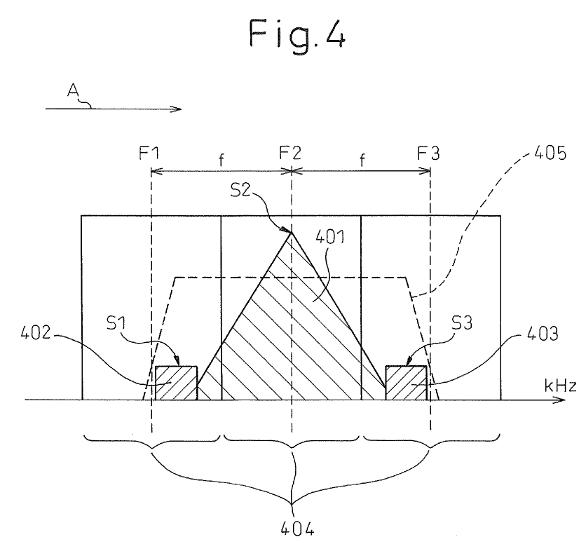

The IF filter circuit 30 includes an NF 31, which is a BPF (Band Pass Filter) having a pass band width of about 100 kHz, and a WF 32, which is a BPF having a pass band width of about 400 kHz, one or the other of which is selected by a control signal from the control section 60. The NF 31 and the WF 32 extract frequency components falling within the respective pass bands centered about the center frequency of the intermediate frequency signal. The pass bands of the NF 31 and WF 32 are shown by way of example in FIG. 4.

The digital signal processing section 40, which is controlled by the control section 60, comprises an IF amplifier circuit 41, an A/D converter circuit 42, a second local oscillator circuit 43, a second mixer circuit 44, an IF processor circuit 45, an IF-AGC circuit 46, a selector circuit 47, and a D/A converter circuit 48.

The IF signal passed through the IF filter circuit 30 is amplified by the IF amplifier circuit 41 and converted by the A/D converter circuit 42 into a digital signal; the digital signal is then mixed in the second mixer circuit 44 with a second local oscillator signal output from the second local oscillator circuit 43, and the resulting signal is fed to the IF processor circuit 45. The IF processor circuit 45 also functions as a demodulator for an analog broadcast carrier wave, and supplies the decoded audio signal to the selector circuit 47 when the input signal is an analog broadcast carrier wave; on the other hand, when the input signal is a digital broadcast carrier wave, the signal is supplied to the IBOC processing section 50. The IF amplifier circuit 41 is constructed so that its gain is adjusted by the IF-AGC circuit 46.

The IBOC processing section 50 comprises a demodulator 51 and a channel decoder 52, and is controlled by the controller 60. The modulator 51 has a function for demodulating the OFDM (Orthogonal Frequency Division Multiplex) subcarriers contained in digital broadcast carrier waves. When the demodulated signal is an audio signal, the audio signal is generated by the channel decoder 52 and fed to the selector circuit 47. On the other hand, when the demodulated signal contains SIS data (text data or video data), the text data or video data is generated by a dedicated decoder not shown, and stored in the storage section 70. The stored text data or video data is output at an appropriate timing for display, etc. on a display section (not shown). Here, when text data or video data is generated, it can be determined that the demodulated broadcast wave is a digital broadcast carrier wave.

The control section 60 controls the selector circuit 47 to select either the audio signal decoded from the analog broadcast carrier wave or the audio signal decoded from the digital broadcast carrier wave. The audio signal selected by the selector circuit 47 is converted by the D/A converter circuit 48 into an analog signal which is output to the output means 90 such as an automotive speaker.

The operation section 80 includes various buttons and knobs for tuning, volume setting, etc. The operation section 80 further includes at least an upward (the direction in which the frequency increases) seek button and a downward (the direction in which the frequency decreases) seek button.

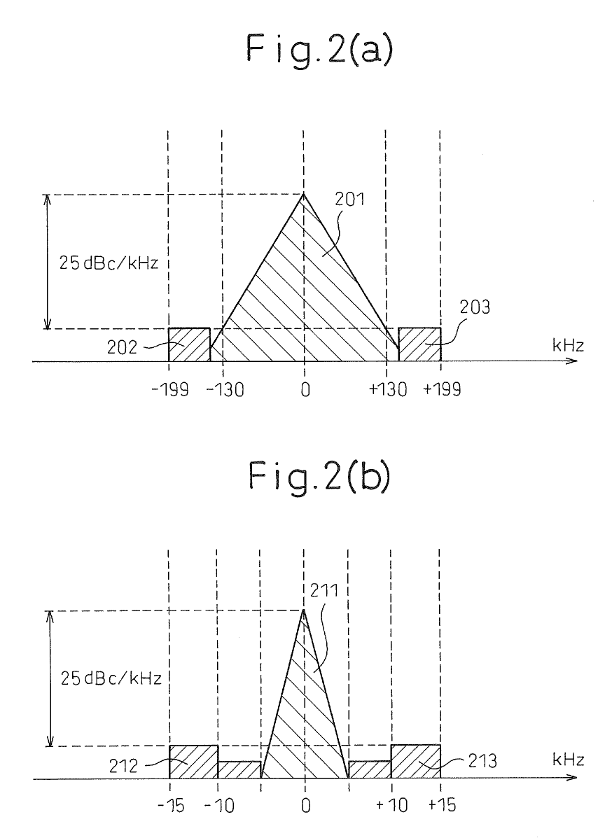

FIG. 2 is a diagram showing IBOC hybrid broadcast carrier waves. FIG. 2(a) shows the case of an FM wave, and FIG. 2(b) shows the case of an AM wave.

As shown in FIG. 2(a), digital broadcast carrier waves 202 and 203 are placed adjacent to the upper and lower sidebands in the frequency band of an analog broadcast carrier wave (FM analog signal) 201. The digital broadcast carrier waves 202 and 203 comprise, for example, a plurality of OFDM modulated subcarriers, and occupy spectral regions, one extending from 130 kHz to 199 kHz and the other from −130 kHz to −199 kHz from the center frequency of the FM analog signal, as shown in the figure. Further, the peak values of the digital broadcast carrier waves 202 and 203 are each set to −25 dB/kHz relative to the peak value of the FM analog signal.

As shown in FIG. 2(b), digital broadcast carrier waves 212 and 213 are placed adjacent to the upper and lower sidebands in the frequency band of an analog broadcast carrier wave (AM analog signal) 211. The digital broadcast carrier waves 212 and 213 comprise, for example, a plurality of OFDM modulated subcarriers, and occupy spectral regions, one extending from 5 kHz to 15 kHz and the other from −5 kHz to −15 kHz from the center frequency of the AM analog signal, as shown in the figure. Further, the peak values of the digital broadcast carrier waves 212 and 213 are each set to −25 dB/kHz relative to the peak value of the AM analog signal.

When only analog broadcasts are being transmitted, only analog broadcast carrier waves exist at prescribed intervals within the frequency band. However, when analog broadcast carrier waves and IBOC hybrid broadcast carrier waves exist within the same radio spectrum, the digital broadcast carrier waves are located close to other analog broadcast carrier waves or digital broadcast carrier waves, and an HD radio receiver performing a seek operation may not be able to correctly receive the intended broadcast carrier waves.

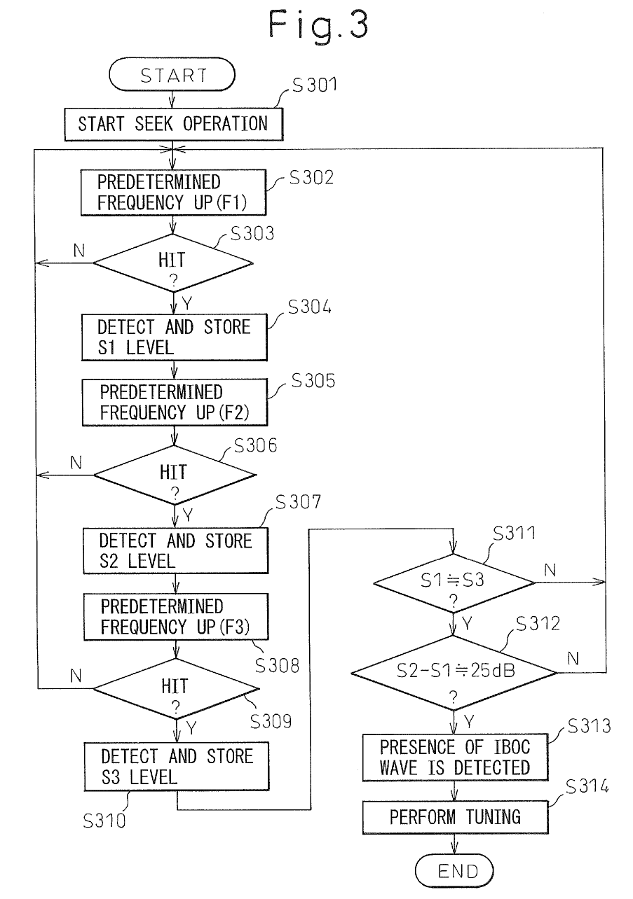

FIG. 3 is a diagram showing a process flow of the radio receiving method according to the present invention which solves the above problem.

The receiving process flow is executed primarily by the control section 60 controlling the various component elements in collaborative manner in accordance with programs prestored in the control section 60, etc. of the radio receiver shown in FIG. 1. Prior to the execution of the flow shown in FIG. 1, power is turned on to the radio receiver 1 to make the various component elements ready to operate.

The process is initiated when a user operates a designated button (for example, the upward seek or downward seek button) on the operation section 80 (S301).

In response to the seek operation start instruction, the control section 60 controls the preprocessing section 20 so as to increase the tuning frequency by a predetermined frequency step (for example, 200 kHz), and performs an operation for tuning to that frequency (F1) (S302). At the same time, the control section 60 controls the IF filter circuit 30 so that the NF 31 can be used. Further, the control section 60 acquires the S level signal from the RF-AGC circuit 23 and determines whether there is a broadcast carrier wave (S303). The determination as to the presence or absence of a broadcast carrier wave is made based on the signal level, etc. of the S level signal. If it is determined that there is no broadcast carrier wave (no hit has occurred), the process returns to S302, and the tuning frequency is further increased by the predetermined frequency step, and the above operation is repeated.

If it is determined in S303 that there is a broadcast carrier wave (a hit has occurred), the signal level (S1) of the S level signal at that instant in time is stored in the storage section 70 under the control of the control section 60 (S304).

Next, the control section 60 further increases the tuning frequency by the predetermined frequency step, and performs an operation for tuning to that frequency (F2) (S305). At the same time, the control section 60 controls the IF filter circuit 30 so that the NF 31 can be used. Further, the control section 60 acquires the S level signal from the RF-AGC circuit 23 and determines whether there is any broadcast carrier wave (S306). If it is determined that there is no broadcast carrier wave (no hit has occurred), the process returns to S302, and the tuning frequency is further increased by the predetermined frequency step, and the above operation is repeated.

If it is determined in S306 that there is a broadcast carrier wave (a hit has occurred), the signal level (S2) of the S level signal at that instant in time is stored in the storage section 70 under the control of the control section 60 (S307).

Next, the control section 60 further increases the tuning frequency by the predetermined frequency step, and performs an operation for tuning to that frequency (F3) (S308). At the same time, the control section 60 controls the IF filter circuit 30 so that the NF 31 can be used. Further, the control section 60 acquires the S level signal from the RF-AGC circuit 23 and determines whether there is any broadcast carrier wave (S309). If it is determined that there is no broadcast carrier wave (no hit has occurred), the process returns to S302, and the tuning frequency is further increased by the predetermined frequency step, and the above operation is repeated.

If it is determined in S309 that there is a broadcast carrier wave (a hit has occurred), the signal level (S3) of the S level signal at that instant in time is stored in the storage section 70 under the control of the control section 60 (S310).

Next, the control section 60 compares S1 and S3 stored in the storage section 70, and determines whether the signal levels S1 and S3 are substantially equal to each other (S311). As earlier described, in the case of an IBOC hybrid broadcast carrier wave, the signal levels of the digital broadcast carrier waves are substantially equal to each other; therefore, if the signal levels S1 and S3 greatly differ from each other, it is determined that the broadcast carrier waves are not those contained in an IBOC hybrid broadcast carrier wave, and the process returns to S302 to repeat the above operation.

If it is determined in S311 that the signal levels S1 and S3 are substantially equal to each other, then it is determined whether the signal level difference between S2 and S1 (or S3) substantially corresponds to 25 dB/kHz (S312). As earlier described, in the case of an IBOC hybrid broadcast carrier wave, the level difference between the analog broadcast carrier wave and the digital broadcast carrier wave is set approximately equal to 25 dB/kHz; therefore, if the signal level difference between S2 and S1 (or between S2 and S3) is not substantially equal to 25 dB/kHz, it is determined that the broadcast carrier waves are not those contained in an IBOC hybrid broadcast carrier wave, and the process returns to S302 to repeat the above operation.

If it is determined in S312 that the signal level difference between S2 and S1 (or between S2 and S3) is substantially equal to 25 dB/kHz, the control section 60 determines that an IBOC hybrid broadcast carrier wave has been detected (S313). At the same time, the control section 60 controls the IF filter circuit 30 so that the WF 32 can be used. Further, the control section 60 tunes to the digital broadcast carrier wave (F1 or F3) (S314), the OFDM subcarriers contained in the digital broadcast carrier wave are decoded by the IBOC processing section 50, and the selector circuit 47 is controlled so as to output the audio signal. In this way, the radio receiver can be correctly tuned to the IBOC hybrid broadcast carrier wave to provide a high-quality audio output.

FIG. 4 is a diagram showing the relationships between the IBOC hybrid broadcast carrier wave and the tuning frequencies F1 to F3 and the signal levels S1 to S3.

In FIG. 4, an arrow A indicates the direction of the upward seek operation (the direction in which the frequency increases) and, as earlier described, the digital broadcast carrier waves 402 and 403 are placed in sidebands above and below the analog broadcast carrier wave 401. The difference between the tuning frequencies F1 and F2 or F2 and F3 corresponds to the predetermined frequency step (f: for example, 200 kHz) described above. Further, reference numeral 404 indicates the pass band width of the NF 31 in the IF filter circuit 30 of the radio receiver 1, and 405 the pass band width of the WF 32.

In the radio receiving method according to the present embodiment, a determination as to the presence or absence of a broadcast carrier wave has been made in each of three adjacent predetermined frequency steps (three adjacent channels) (S303, S306, and S309 in FIG. 3). However, the determination may be made at once after storing all the three S level signals.

Further, in the radio receiving method according to the present embodiment, even when it is determined in S309 in FIG. 3 that there is a broadcast carrier wave, the process has been made to further proceed to the decision steps S311 and S312. However, when there exist broadcast carrier waves on three adjacent channels, it can be determined that it is highly likely that the broadcast carrier waves are those contained in an IBOC hybrid broadcast carrier wave such as shown in FIG. 4. Accordingly, if it is desired to determine in a simple way whether or not the broadcast carrier waves are those contained in an IBOC hybrid broadcast carrier wave, the decision steps S311 and S312 in FIG. 3 may be omitted.

Furthermore, in the radio receiving method according to the present embodiment, even when it is determined in S311 in FIG. 3 that the signal levels S1 and S3 are substantially equal to each other, the process has been made to further proceed to the decision step S312. However, when there exist broadcast carrier waves on three adjacent channels, and when the signal levels S1 and S3 are substantially equal to each other, it can be determined that it is even more highly likely that the broadcast carrier waves are those contained in an IBOC hybrid broadcast carrier wave such as shown in FIG. 4. Accordingly, the decision step S312 in FIG. 3 may be omitted.

Moreover, in the radio receiving method according to the present embodiment, the radio receiver 1 has performed processing such as tuning and detection of the S level signal value by using only one preprocessing section 20. However, since it takes a finite time to perform the processing for each predetermined frequency step, a plurality of preprocessing sections 20 (that is, a plurality of sets of tuning/detection sections) may be provided so that, while the processing for tuning is being performed in one set, the processing for S level signal detection, etc. can be performed in another set. In this way, by providing a plurality of preprocessing sections 20, it becomes possible to increase the detection speed in the seek operation.

In the present embodiment, as earlier described, the determination as to whether an IBOC hybrid broadcast carrier wave has been detected or not has been made based at least on whether broadcast carrier waves have been detected on three adjacent channels. However, when an audio signal corresponding to a digital broadcast carrier wave is output from the channel decoder 52 in the IBOC processing section 50, it can be determined that the currently tuned broadcast carrier wave is a digital broadcast carrier wave (either 402 or 403 in FIG. 4). Accordingly, if it is desired to detect the presence of an IBOC hybrid broadcast carrier in a simpler way, the control section 60 may be configured to determine whether an IBOC hybrid broadcast carrier wave has been detected or not by detecting the output of the channel decoder 52 in the IBOC processing section 50, rather than following the procedure shown in the receiving process flow of FIG. 3.

Further, as previously described, when the IBOC processing section 50 has an SIS data decoder (not shown) for outputting SIS data (text data or video data), then when SIS data is output it can be determined that the currently tuned broadcast carrier wave is a digital broadcast carrier wave (either 402 or 403 in FIG. 4). Accordingly, if it is desired to detect the presence of an IBOC hybrid broadcast carrier in a simpler way, the control section 60 may be configured to determine whether an IBOC hybrid broadcast carrier wave has been detected, or not, by detecting the output of the SIS data decoder, rather than following the procedure shown in the receiving process flow of FIG. 3.

What is claimed is:

1. A radio receiver, comprising:
a tuning section for tuning to the frequency of a broadcast carrier wave;
a detection section for detecting signal level of said broadcast carrier wave at the frequency to which said tuning section has tuned; and
a control section for detecting an IBOC hybrid broadcast carrier wave, based on a first signal level detected by said detection section by causing said tuning section to tune to a first frequency, a second signal level detected by said detection section by causing said tuning section to tune to a second frequency, and a third signal level detected by said detection section by causing said tuning section to tune to a third frequency.

2. The radio receiver according to claim 1, wherein said control section determines that an IBOC hybrid broadcast carrier wave has been detected when said first signal level, said second signal level, and said third signal level are each larger than a predetermined level.

3. The radio receiver according to claim 2, wherein said control section determines that an IBOC hybrid broadcast carrier wave has been detected when said first signal level and said third signal level are substantially equal to each other.

4. The radio receiver according to claim 2, wherein said control section determines that an IBOC hybrid broadcast carrier wave has been detected when a difference between said first signal level and said second signal level is substantially equal to a predetermined level difference.

5. The radio receiver according to claim 2, wherein said control section determines that an IBOC hybrid broadcast carrier wave has been detected when said first signal level and said third signal level are substantially equal to each other and when a difference between said first signal level and said second signal level is substantially equal to a predetermined level difference.

6. The radio receiver according to claim 1, wherein said first frequency, said second frequency, and said third frequency are separated from one another by a prescribed frequency interval.

7. The radio receiver according to claim 6, further comprising a plurality of said tuning sections paired with a plurality of said detection sections,
wherein tuning to different frequencies and detection of signal levels at said different frequencies are performed by said plurality of tuning sections and detection sections.

8. A radio receiver, comprising:
a tuning section for tuning to the frequency of a broadcast carrier wave;
a detection section for detecting the signal level of said broadcast carrier wave at the frequency to which said tuning section has tuned;
a generating section for generating SIS data from a digital broadcast carrier wave contained in said broadcast carrier wave; and
a control section for determining that an IBOC hybrid broadcast carrier wave has been detected when the signal level detected by said detection section is larger than a predetermined signal level and when SIS data is generated by said generating section.

9. A radio receiver, comprising:
a tuning section for tuning to the frequency of a broadcast carrier wave;
a detection section for detecting the signal level of said broadcast carrier wave at the frequency to which said tuning section has tuned;
a generating section for generating audio data corresponding to a digital broadcast from a digital broadcast carrier wave contained in said broadcast carrier wave; and
a control section for determining that an IBOC hybrid broadcast carrier wave has been detected when the signal level detected by said detection section is larger than a predetermined signal level and when audio data is generated by said generating section.

10. A radio receiver, comprising:
a tuning section for tuning to the frequency of a broadcast carrier wave;
a detection section for detecting the signal level of said broadcast carrier wave at the frequency to which said tuning section has tuned; and
a control section for detecting an IBOC hybrid broadcast carrier wave based on a level difference between a first signal level, detected by said detection section by causing said tuning section to tune to a first frequency, and a second signal level, detected by said detection section by causing said tuning section to tune to a second frequency which is separated from said first frequency by a prescribed frequency step.

11. The radio receiver according to claim 10, wherein when the difference between said first signal level and said second signal level is substantially equal to a predetermined level difference, said control section determines that an IBOC hybrid broadcast carrier wave has been detected.

12. A radio receiving method, comprising the steps of:
detecting the signal level of a first broadcast carrier wave by tuning to a first frequency;
detecting the signal level of a second broadcast carrier wave by tuning to a second frequency;
detecting the signal level of a third broadcast carrier wave by tuning to a third frequency; and
detecting an IBOC hybrid broadcast carrier wave, based on the signal level of said first broadcast carrier wave, the signal level of said second broadcast carrier wave, and the signal level of said third broadcast carrier wave.

13. A radio receiving method, comprising the steps of:
detecting the signal level of a broadcast carrier wave by tuning to the frequency of said broadcast carrier wave; and
determining that an IBOC hybrid broadcast carrier wave has been detected when said signal level is larger than a predetermined signal level and when SIS data is generated from a digital broadcast carrier wave contained in said broadcast carrier wave.

14. A radio receiving method, comprising the steps of:
detecting the signal level of a broadcast carrier wave by tuning to the frequency of said broadcast carrier wave; and
determining that an IBOC hybrid broadcast carrier wave has been detected when said signal level is larger than a predetermined signal level and when audio data corresponding to a digital broadcast is generated from a digital broadcast carrier wave contained in said broadcast carrier wave.

15. A radio receiving method, comprising the steps of:
detecting the signal level of a first broadcast carrier wave by tuning to a first frequency;
detecting the signal level of a second broadcast carrier wave by tuning to a second frequency; and
detecting an IBOC hybrid broadcast carrier wave, based on a level difference between the signal level of said first broadcast carrier and the signal level of said second broadcast carrier.
